(19) United States
(12) Patent Application Publication
(10) Pub. No.: US 2008/0222853 A1
(43) Pub. Date: Sep. 18, 2008

(54) Shape memory alloy reinforced hoses and clamps

(75) Inventors: Pablo D. Zavattieri, Ann Arbor, MI (US); Alfred A. Gunther, Macomb, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/685,828

(22) Filed: Mar. 14, 2007

(51) Int. Cl. F16L 33/02; F16L 11/00

(52) U.S. Cl. 24/20 R; 138/118; 24/20 S

(57) ABSTRACT

Reinforced hoses and clamps generally include a shape memory alloy material configured to provide tangential forces to the generally circular hoses and clamps. The shape memory alloy can be in the form of a ring embedded within the hose or may be in operative communication with the clamp such that a phase change in the shape memory alloy upon thermal activation provides the tangential forces.

### BACKGROUND

The present disclosure generally relates to hoses and clamps, and more particularly, to hoses and clamps formed, in whole or in part, of a shape memory alloy.

Metal-based spring clamps are commonly employed at different stages of the manufacturing process to connect a hose to a connector. It is important that the clamp is properly connected to avoid potential leaks. In addition, it sometimes may be difficult to ascertain visually whether the clamp has been tightened to a degree effective to prevent leakage. Even if adequately tightened during the initial assembly process in an amount effective to prevent leakage, it is possible that a clamp may loosen due to the vibrations of the operating environment. Still further, for automotive applications, these types of clamps may often used for connecting radiator hoses to a radiator inlet which is subject to extensive thermal cycling.

FIG. 1 illustrates an exemplary prior art hose spring clamp 10. The clamps are typically formed of elongated band of stainless steel. A band 12 having first and second opposed ends which are overlapped to form an annular clamp member includes outer stamped threads (or perforations) 14 and an adjustment assembly 16 in operative communication therewith to define a worm drive for selectively adjusting the clamp diameter. The adjustment assembly includes drive gear having peripheral teeth that engage the stamped threads whereby rotation of the gear results in the first and second ends moving to vary the circumference of the clamp member. The drive gear is driven with an adjustment screw 17 that is positioned perpendicular to the clamp member circumference for easier access. By adjusting the clamp diameter, a hose 18 can be removed or secured to a hose connector 20.

It is, therefore, desirable to provide a clamp that provides for ease of assembly in securing the clamps and to also overcome some of the problems noted in the art.

### BRIEF SUMMARY

Disclosed herein are reinforced hoses and hose clamps. In one embodiment, a hose clamp for securing a hose against a host fitting comprises an elongated band having a first end and a second end configured to form a substantially circular clamp member that defines a hose receiving opening, wherein the elongated band includes a plurality of engageable portions spaced about an outer surface of the band; an adjustment mechanism attached to one end of the elongated band configured for engaging the engageable portions and adjusting a diameter of the hose receiving opening; and a shape memory alloy material in operative communication with the elongated band and configured to provide tangential forces to the circular clamp member.

In another embodiment, a self repairing hose comprises a flexible conduit having a generally circular cross section and an open end adapted to be fitted to a hose fitting; and a ring formed of a shape memory alloy embedded within the generally circular cross section of the flexible conduit, wherein the ring is positioned proximate to the free end such that the ring is disposed about an outer periphery of the hose fitting upon attachment of the hose to the hose fitting. Rings can also be distributed along the length of the hose for those cases where cracks can form randomly regardless the location. In some other cases, cracks are expected in hose elbows or near places where the mechanical or environmental conditions are different or where there contact with other components. In those cases, the rings will be strategically located in those regions.

In yet another embodiment, a hose connection for a high temperature fluid comprises a hose fitting; a flexible conduit having a generally circular cross section and a free end attached to hose fitting; and a pre-strained shape memory alloy in operative communication with the flexible conduit and configured to exert a tangential force against the generally circular cross section and hose fitting upon receiving a thermal load from the high temperature fluid.

The above described and other features are exemplified by the following Figures and detailed description.

### BRIEF DESCRIPTION OF THE DRAWINGS

Referring now to the figures, which are exemplary embodiments and wherein the like elements are numbered alike.

FIG. 1 is a prior art exemplary hose clamp;

FIG. 2 is a partial cutaway perspective view of a hose end including an embedded ring formed of a shape memory alloy;

FIG. 3 is an sectional view of the hose end taken along lines 3-3 of FIG. 2;

FIG. 4 is a perspective view of an exemplary cable tie formed of a shape memory alloy;

FIG. 5 is a sectional view of the cable tie including a shape memory alloy wire configured for providing a tangential force upon activation;

FIGS. 6A, B and C are sectional views illustrating the process of securing a hose to a hose fitting with a hose clam of the present disclosure; and

FIG. 7 is a sectional view of a self-repairing hose.

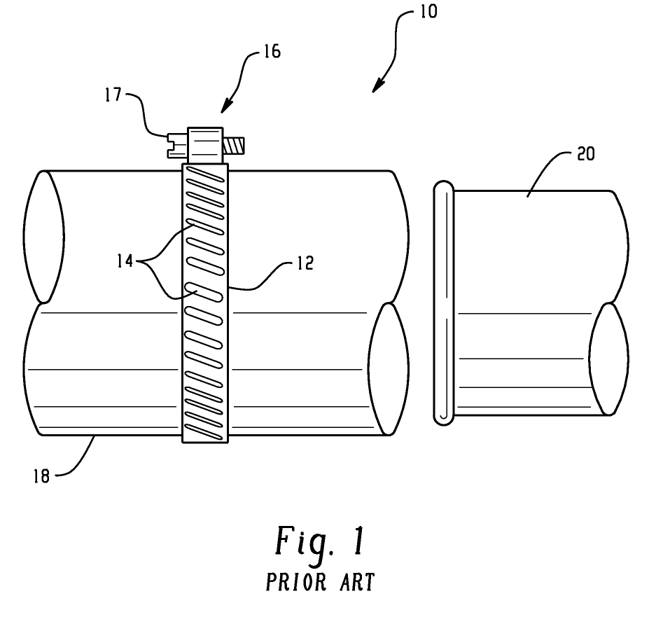

### DETAILED DESCRIPTION

Disclosed herein are hose clamps for securing a hose to a hose connector. The hose clamps are formed, in whole or in part, of a shape memory alloy material. As will be discussed in greater detail below, the shape memory alloy clamps are secured to a hose and hose connector in a cold state, i.e., the shape memory alloy is in its martensite phase, and subsequently heated above its transformation temperature to its so-called austenite phase. The phase transformation from the martensite phase to austenite phase decreases the diameter of the hose clamp. In this manner, heat can be applied to the hose clamp instead of or in addition to mechanical intervention to insure that the clamp is securely fastened in an amount effective to prevent leakage. Application of heat can occur by any means including simple operation of the vehicle. Advantageously, the use of shape memory alloys makes the hose clamp corrosion resistant. And permits the hose clamp to be used in corrosive environments.

Shape memory alloys exhibit properties that are unique in that they are typically not found in other metals. The shape memory effect is manifested when the metal is first severely deformed by bending, pressure, shear, or tensile strains in its cold state. The accumulated strain can then be removed by increasing the temperature above its transformation temperature that allows it to recover its original shape in its hot state. In this way, the material appears to “remember” its original shape. Shape memory alloys exhibiting a one-way shape memory effect do not return to its deformed shape by returning to its cold state. Any desired deformation should be stress-induced in its cold state. The underlying microstructural effect is based upon stress-induced detwinning (deformation) in its cold state and temperature-induced martensitic-to-austenitic phase transformation (shape recovery). Alternatively, superelasticity, which is the other main property of shape memory alloys, allows these materials to be deformed via a stress-induced austenitic-to-martensitic phase transformation in its hot state. In tension, a linear stress-strain curve is noted as the austenitic material deforms until the martensitic transformation. The strain then increases at constant stress (i.e. the stress-strain curve reaches a plateau) until all of the material is martensite. The material recovers its shape when the stress is released leading to an inverse phase transformation. Note that cold and hot states are relative to the transformation temperatures that can be tailored to specific applications. For example, for some SMA wires usually sold for actuation purposes, the cold state is at room temperature and actuation is achieved by heating the wires to above (70 or 90° C.). On the other hand, shape memory alloys used for cell phone antennas and eyeglasses frames are usually in their hot state at room temperature and only their Superelastic properties are used. Another advantage of shape memory alloys over other metals typically used for hose clamps is their good resistance to corrosion.

By way of background, shape memory alloys are alloy compositions with at least two different temperature-dependent phases. The most commonly utilized of these phases are the so-called martensite and austenite phases. In the following discussion, the martensite phase generally refers to the more deformable, lower temperature phase whereas the austenite phase generally refers to the more rigid, higher temperature phase. When the shape memory alloy is in the martensite phase and is heated, it begins to change into the austenite phase. The temperature at which this phenomenon starts is often referred to as the austenite start temperature (Aₛ). The temperature at which this phenomenon is complete is called the austenite finish temperature (A_{f}). When the shape memory alloy is in the austenite phase and is cooled, it begins to change into the martensite phase, and the temperature at which this phenomenon starts is referred to as the martensite start temperature (Mₛ). The temperature at which austenite finishes transforming to martensite is called the martensite finish temperature (M_{f}). It should be noted that the above-mentioned transition temperatures are functions of the stress experienced by the SMA sample. Specifically, these temperatures increase with increasing stress. In view of the foregoing properties, deformation of the shape memory alloy is preferably carried out at or below the austenite transition temperature. Subsequent heating above the austenite transition temperature causes the deformed shape memory material sample to revert back to its permanent shape. Thus, a suitable activation signal for use with shape memory alloys is a thermal activation signal having a magnitude that is sufficient to cause transformations between the martensite and austenite phases.

The austenite finish temperature, i.e., the temperature at which the shape memory alloy remembers its high temperature form when heated, can be adjusted by slight changes in the composition of the alloy and through thermo-mechanical processing. In nickel-titanium shape memory alloys, for example, it can be changed from above about 270° C. to below about −100° C. The shape recovery process can occur over a range of just a few degrees or exhibit a more gradual recovery. The start or finish of the transformation can be controlled to within a degree or two depending on the desired application and alloy composition. The mechanical properties of the shape memory alloy vary greatly over the temperature range spanning their transformation, providing shape memory effect, superelastic effect, and high damping capacity. For example, in the martensite phase a lower elastic modulus than in the austenite phase is observed. Shape memory alloys in the martensite phase can undergo large deformations by realigning the crystal structure rearrangement with the applied stress. The material will retain this shape after the stress is removed.

As noted above, shape recovery occurs when the shape memory alloy SMA undergoes deformation while in the malleable low-temperature phase and then encounters heat greater than the transformation temperature (i.e., austenite finish temperature). Recovery stresses can exceed 400 megapascals (60,000 psi). Recoverable strain is as much as about 8% (about 4% to about 5% for the copper shape memory alloys) for a single recovery cycle and generally drops as the number of cycles increases.

The SMA may be in the form of a band, a sheet, a wire, a tube, a rod, a bar, or the like. The specific form as well as composition is not intended to be limited. Suitable shape memory alloy materials include, but are not intended to be limited to, nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, and the like. The alloys can be binary, ternary, or any higher order so long as the alloy composition exhibits a shape memory effect, e.g., change in shape, orientation, yield strength, flexural modulus, damping capacity, superelasticity, and/or similar properties. Selection of a suitable shape memory alloy composition depends on the temperature range where the component will operate. In an exemplary embodiment, the SMA comprises a nickel titanium alloy.

The shape of the SMA may be planar, curved or in any other shape. It will, therefore, be understood that the use of the term SMA herein is intended to include all such SMA materials, forms, and shapes.

As used herein, the terms “cold state” refers to when the shape memory alloy is at a temperature below its martensite finish temperature M_{f} (term globally accepted in the open literature). In this state the material can deform by applied stress from the twinned to the detwinned variant. The term and “hot state” refers to when the shape memory alloy is above its austenite finish temperature A_{f}. At zero stress, the shape memory alloy recovers its shape. Also under isothermal conditions the material exhibits a stress-induced superelastic behavior when it is initially in its austenitic phase (or when the temperature is above its A_{f}). That means that it is a stress-induced austenitic-to-martensitic phase transformation).

Suitable shape memory alloys can be made such that they are in either cold or hot state at room temperature. As previously discussed, the transformation temperatures, M_{f} and A_{f} can be tailored according to the needs. One possibility is to set the M_{f} temperature above the room temperature. In this case the material can deform at room temperature and fastening can be accomplished by heating the SMA above its A_{f} temperature. In automotive applications, the temperatures can be obtained with heating by any means during the manufacturing process e.g., induced heating, a heat gun and the like or by a first engine service. An optional locking mechanism may be employed to keep the clamp tied. Subsequent heating cycles of the engine ensures that the clamp will continue to shrink in service to compensate for any compression set in the hose. In another embodiment, the A_{f} temperature of the shape memory alloy is set well below room temperature (some commercially available SMAs are offered with an A_{f} below the freezing temperature). In this embodiment, the deformation and positioning of the smart clamp should be done at T<M_{f} (e.g., by using liquid nitrogen). Activation (and shrinkage) of the clamp is automatically achieved at room temperature. In this case, the locking mechanism may not be needed if the clamps stay at above A_{f}.

By way of example, a ring-shaped clamp containing the pre-strained shape memory alloy can be placed embedded or around the hose connection region. This “smart clamp” can be open, closed on in spiral form but sized for a particular hose diameter. At the moment of placement, the shape memory alloy is in its cold state and it can be deformed so it can be connected to the fitting. Fastening occurs by increasing the temperature of the shape memory alloy to its hot state shrinking (or reducing the radius of) the smart clamp. The clamping force can be maintained either by heat from the fluid or the environment (e.g., heat from the coolant inside the hose or from the engine) which forces the shape memory alloy to shrink in service or by using some locking mechanism (a strap that only needs to be fastened during the first service).

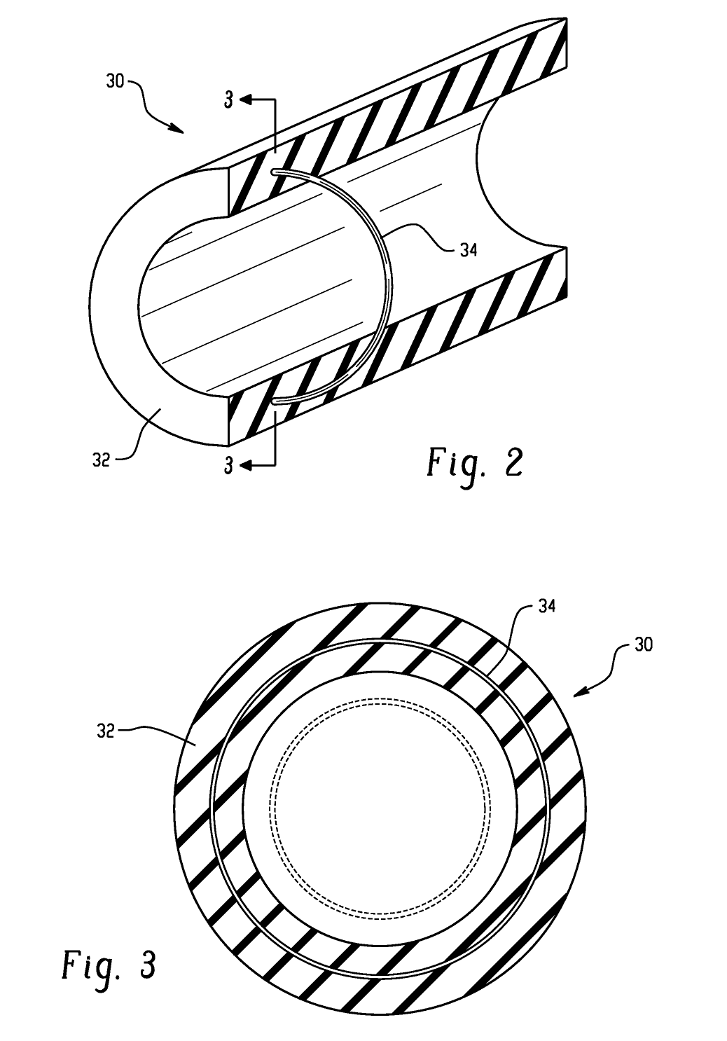

As previously discussed, reducing the radius of the shape memory alloy hose clamp and the subsequent clamping/fastening force is achieved by using the shape memory property. FIGS. 2 and 3 illustrate an exemplary clamp ring 30 that includes a shape memory alloy ring 34 that is embedded at a distal end of a hose 32. The clamp ring is exemplary only and not intended to be limiting. As shown more clearly in the sectional view of FIG. 3, the undeformed SMA clamp ring is expanded in its cold state (detwinning of its martensitic phase) and remains deformed as it is embedded in or placed outside the hose. An increase in temperature (above its austenitic phase temperature transformation—hot state) forces the shape memory alloy clamp ring to recover its original shape (shown in dashed lines). Due to the constraint offered by the hose and fitting, the clamp ring does not completely return to its original shape exerting circumferential forces inside the hose that translates into contact pressures in the hose/fitting interface producing a robust seal. The same shape memory effect can be used to produce clamping forces by bending of thick pieces of open shape memory alloy rings.

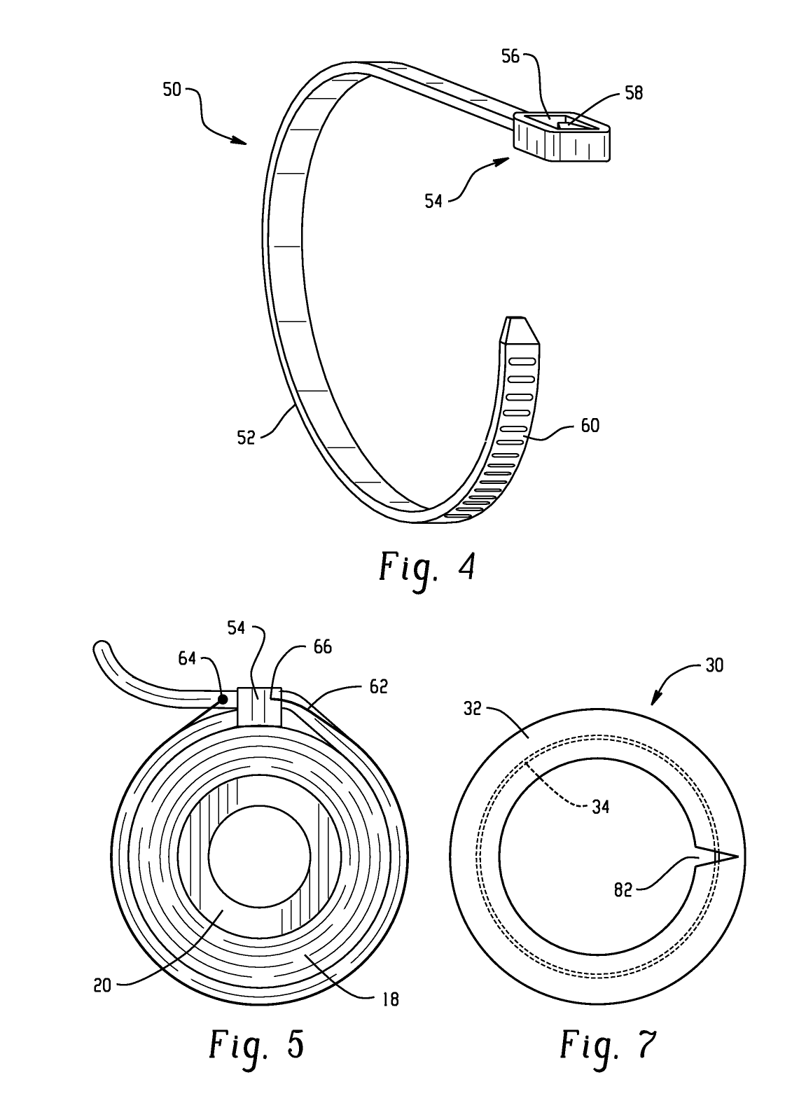

FIGS. 4 and 5 illustrate yet another embodiment of a shape memory alloy hose clamp 50 for connecting a hose to a hose fitting (i.e., connector). The clamp 50 is in the form of cable tie and includes an elongate, flexible strap or band portion 52 and a head portion 54 all molded as a single piece. The head portion 54 includes a housing 56 that defines a transverse aperture formed therethrough and contains a barb 58. The strap includes an engaging portion 60 that is unidirectional oriented such that the barb 58 engages the engaging portion 60 after insertion of the strap into the aperture. The barb 58 includes a flexure region and is oriented such that the strap can be inserted into the aperture and move freely in one direction. The barb is anchored to the engaging portion upon application of force in the counter direction. In FIG. 4, the entire cable is formed of the shape memory alloy. Because of this, the clamping force occurs under bending, unlike the tangential forces as described in the next embodiment.

In FIG. 5, the clamp is not formed of a shape memory alloy but includes a shape memory alloy ribbon, wire, or the like, 62 having one end 64 fixedly attached to an end of the strap (after insertion into the transverse aperture) and an other end 66 fixedly attached to the head portion 54. In this manner, the shape memory alloy can compensate for any permanent deformation of the hose (compression set) due to thermal cycling. Optionally, the hose clamp 50 can be used to provide the necessary force to tighten the clamp/strap to the point where the clamp has the necessary clamping force exerted onto the hose/fitting interface for good sealing.

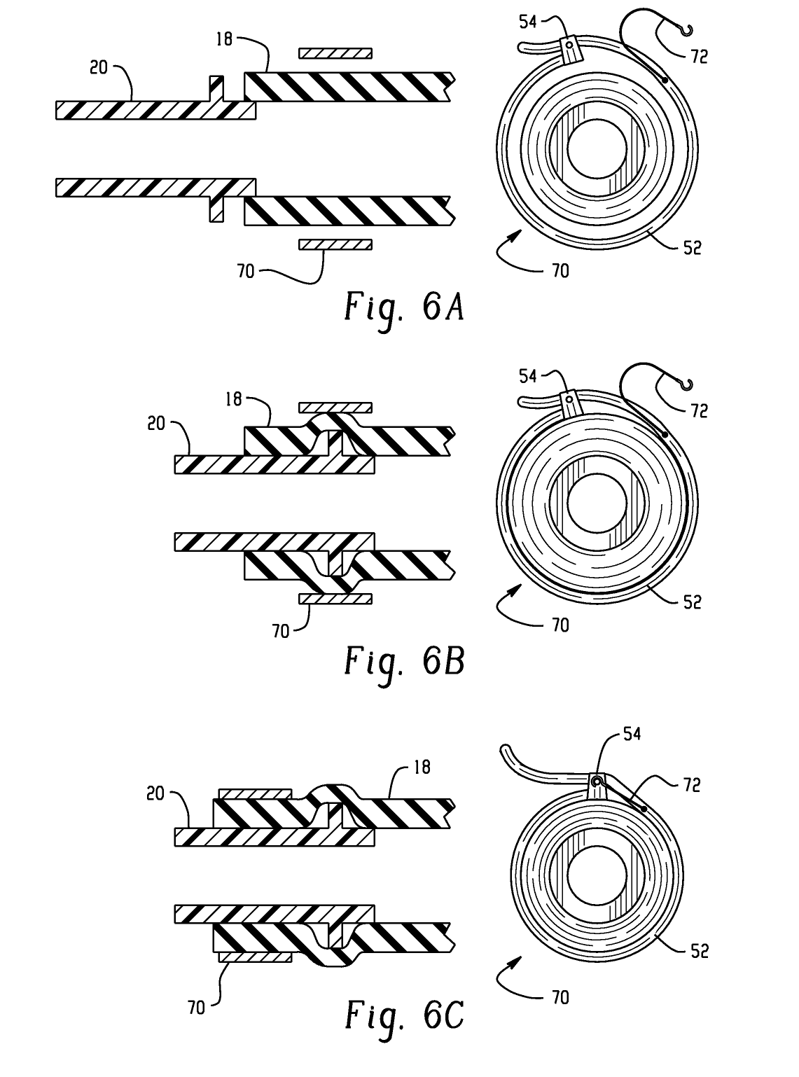

Referring now to FIGS. 6A, B, and C, there is shown an exemplary process and hose clamp for securing a hose against a hose fitting. In this embodiment, the hose clamp 70 includes a shape memory alloy wire 72 that is fixedly attached at one end to the strap 52 and in a location that is proximate to the head portion 54. In one embodiment, the shape memory wire is attached at a location proximate to the free end of the strap. The shape memory alloy wire is attached to the head portion once the clamp is initially fastened. As shown, a hose is first positioned in the mouth of the fitting and the clamp is open without the shape memory alloy being locked. Next, the hose is passing through the tee-shaped profiled fitting, wherein the clamp remains open leaving enough clearance for the hose to expand radially to accommodate the radius of the tee portion. The hose clamp 70 is then tightened manually by applying a pull force on the strap such that the head portion engages the engaging portion of the strap followed by increasing the temperature of the shape memory alloy wire above its transformation temperature A_{f}. The heat treatment causes a tangential force to be applied against the hose 20 and hose fitting 18, which is effective to provide sealing engagement and compensate for permanent compression of the hose.

As a specific example, a commonly employed hose used in automotive applications has an outer diameter of 42 mm. The clamping force (tangential force) needed for sealing is about 500 Newtons. To provide an estimate of how much shape memory material is needed, the following simple calculation can be used and will assume the following: (1) The SMA is considered in wire form with typical wire diameters of 200, 250, 380 and 500 microns). (2) These wires have the capability to provide a maximum stress of 0.8-1 GPa (recall that we only need one life cycle required to fasten the clamp once at the manufacturing stage). A maximum length per wire equal to the outer diameter of the hose is considered L=Dπ=131.9 mm. The calculations are summarized in the following table.

| | | | Fₘₐₓ [N] | |
|---|---|---|---|---|
| Ø [mils] | Ø [μm] | A [mm²] | (0.8/1 GPa) | # of wires |
| 8 | 203 | 0.0323 | 25.8/32.3 | 16–20 |
| 10 | 254 | 0.0506 | 40.5/50.6 | 10–13 |
| 15 | 381 | 0.1140 | 91.2/114 | 5–6 |
| 20 | 508 | 0.1990 | 160/200 | 3–4 |

This table contains an estimate of the added price of each clamp (price only given by the shape memory alloy). The first two columns indicate the possible (commercially available) wire diameters considered in this calculation. The third column is the cross-section area of the wires. The forces indicated in the fourth column are the maximum force that these wires can exert if a maximum stress of 0.8/1.0 GPa is considered. Given the length of 131.9 mm (as a maximum number) and the need to provide a 500 N in total, the numbers of wires are indicated in the sixth column. It should be noted that the calculations provide only an estimate and may vary depending on other factors. For example, for a tee-shaped profile, if the clamp is initially tighten enough the remaining contraction needed to provide the required force may be smaller.

Referring now to FIG. 7, another possible function for these shape memory alloy clamps is the self-repairing capability to close internal cracks near the region of contact and therefore prevent the crack to grow. Since the purpose of this function is different than the previously discussed ability to tighten the hose into the connector, the design parameters may vary in this case. For example, as shown in FIG. 7, an internal crack 82 in the hose 30 may be generated by various mechanical and environmental conditions. In the case where the hose carries a thermal load of a fluid, the embedded pre-strained SMA ring 34 located in the hose as shown in the Figure will contract if the fluid gets near (or in contact) with the wire. The force exerted by the wire will close the crack 82 and prevent it from growing further during operation at high temperature.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A hose clamp for securing a hose against a host fitting, the hose clamp comprising:
an elongated band having a first end and a second end configured to form a substantially circular clamp member that defines a hose receiving opening, wherein the elongated band includes a plurality of engageable portions spaced about an outer surface of the band;
an adjustment mechanism attached to one end of the elongated band configured for engaging the engageable portions and adjusting a diameter of the hose receiving opening; and
a shape memory alloy material in operative communication with the elongated band and configured to provide tangential forces to the circular clamp member.

2. The hose clamp of claim 1, wherein the adjustment mechanism comprises a drive gear having peripheral teeth engage the plurality of engageable portions.

3. The hose clamp of claim 1, wherein the adjustment mechanism comprises a housing defining a transverse aperture disposed at the second end of the elongated band, wherein the transverse aperture is configured to receive the first end of the elongated band and comprises a barb for unidirectionally engaging the engageable portions.

4. The hose clamp of claim 3, wherein the shape memory alloy material has an end fixedly attached to the elongated band and another end attached to the housing and configured to exert a tangential force to the elongated band upon activation thereof.

5. The hose clamp of claim 1, wherein the elongated band defines a spring clamp.

6. The hose clamp of claim 1, wherein the elongated band defines a cable tie.

7. The hose clamp of claim 1, wherein the shape memory alloy is configured to contract upon thermal activation.

8. The hose clamp of claim 1, wherein the shape memory alloy is selected from a group consisting of nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, and iron-palladium based alloys.

9. A self repairing hose, comprising
a flexible conduit having a generally circular cross section and an open end adapted to be fitted to a hose fitting; and
a ring formed of a shape memory alloy embedded within the generally circular cross section of the flexible conduit, wherein the ring is positioned proximate to the open end such that the ring is disposed about an outer periphery of the hose fitting upon attachment of the hose to the hose fitting.

10. The self repairing hose of claim 9, wherein the shape memory alloy is selected from a group consisting of nickel-titanium based alloys, indium-titanium based alloys, nickel-aluminum based alloys, nickel-gallium based alloys, copper based alloys, gold-cadmium based alloys, silver-cadmium based alloys, indium-cadmium based alloys, manganese-copper based alloys, iron-platinum based alloys, and iron-palladium based alloys.

11. The self repairing hose of claim 9, wherein the ring formed of the shape memory alloy is configured to decrease a diameter of the generally circular cross section upon thermal activation.

12. The self repairing hose of claim 11, wherein the decrease in the diameter of the generally circular cross section is in an amount effective to close an internal crack in the flexible conduit.

13. A hose connection for a high temperature fluid, comprising:
a hose fitting;
a flexible conduit having a generally circular cross section and a free end attached to hose fitting; and
a pre-strained shape memory alloy in operative communication with the flexible conduit and configured to exert a tangential force against the generally circular cross section and hose fitting upon receiving a thermal load from the high temperature fluid.

14. The hose connection of claim 13, wherein the pre-strained shape memory alloy is a ring embedded within the generally circular cross section of the flexible conduit and is positioned to exert the tangential force on the hose fitting upon receipt of the thermal load.

15. The hose connection of claim 13, wherein the shape memory alloy is selected from a group consisting of nickel-titanium based alloys, indium-titanium based alloys, nickel-aluminum based alloys, nickel-gallium based alloys, copper based alloys, gold-cadmium based alloys, silver-cadmium based alloys, indium-cadmium based alloys, manganese-copper based alloys, iron-platinum based alloys, and iron-palladium based alloys.

16. The hose connection of claim 13, wherein the pre-strained shape memory alloy is an elongated band having a first end and a second opposing end overlapped to form a substantially circular clamp member about the perimeter of the flexible conduit, wherein the elongated band includes a plurality of engageable portions spaced about an outer surface of the band; and an adjustment mechanism attached to one end of the elongated band configured for engaging the engageable portions and adjusting a diameter clamp member.

17. The hose connection of claim 13, wherein the pre-strained shape memory alloy is a cable tie.

18. The hose connection of claim 13, wherein the pre-strained shape memory alloy is a band formed about a perimeter of the flexible conduit.

19. The hose connection of claim 13, wherein the shape memory alloy is a wire fixedly attached at one end to an elongated band and at another end to an adjustment mechanism, wherein the elongated band comprises a plurality of engageable portions and the adjustment mechanism comprises a housing defining a transverse aperture and a barb for unidirectionally engaging the engageable portions, wherein the housing is configured to receive a free end of the elongated band.

20. The hose connection of claim 13, wherein the hose fitting has a tee shaped profile.
